(19) United States
(12) Patent Application Publication
(10) Pub. No.: US 2026/0276805 A1
(43) Pub. Date: Sep. 17, 2026

(54) ELECTRONIC DEVICE AND METHOD FOR IDENTIFYING THE MOTION OF A TARGET OBJECT

(71) Applicant: Samsung Electronics Co., Ltd., Suwon-si (KR)

(72) Inventors: Kyungwoo YOO, Suwon-si (KR); Taewoo YU, Suwon-si (KR); Dooseok CHOI, Suwon-si (KR)

(73) Assignee: Samsung Electronics Co., Ltd., Suwon-si (KR)

(21) Appl. No.: 19/544,345

(22) Filed: Feb. 19, 2026

(30) Foreign Application Priority Data
Mar. 13, 2025 (KR) 10-2025-0032525

(51) Int. Cl. G01S 13/58; G01S 7/41

(52) U.S. Cl. CPC G01S 13/58; G01S 7/41

(57) ABSTRACT

An electronic device includes a radar antenna configured to transmit and receive an RF signal, and a processor configured to identify motion of a target object based on a signal received through the radar antenna. The processor configured to obtain a Doppler velocity of the target object, and power of a tone signal obtained in an operation of detecting the target object during a measurement time, obtain a power distribution of the tone signal according to the Doppler velocity, calculate a first correlation value between the power distribution and a first reference distribution corresponding to first motion of the target object, and a second correlation value between the power distribution and a second reference distribution corresponding to second motion of the target object, and determine the motion of the target object as the first motion in response to the first correlation value being greater than the second correlation value.

### CROSS-REFERENCE TO RELATED APPLICATION

This application claims priority under 35 U.S.C. § 119 to Korean Patent Application No. 10-2025-0032525 filed on Mar. 13, 2025, in the Korean Intellectual Property Office, the disclosures of which are incorporated by reference herein in their entireties.

### BACKGROUND

Example embodiments of the present inventive concepts described herein relate to electronic devices and/or methods for identifying the motion of a target object.

Radio-detection-and-ranging (radar) is a technology that detects a target object by measuring the reflected waves that return after the irradiated electromagnetic waves hit the target object, and determines the direction, distance, and speed of the target object based on the measurement subject (e.g., the radar).

Nowadays, with the development of Internet of Things (IoT) technology, radars are being installed in various devices such as portable terminals (e.g., smart phones), home appliances, kiosks, and vehicles, etc.

For example, to satisfy the demands for miniaturization, weight reduction, and/or minimization of power consumption of various devices, devices equipped with radars utilizing only a 1T1R antenna (e.g., a one transmit and one receive antenna) that transmits and receives a single signal through a single antenna element, are increasing.

Here, radars utilizing the 1T1R antenna may identify the motion of a target object by using the distance from a measurement subject to the target object and the Doppler velocity of the target object.

However, when utilizing 1T1R antenna radars, there may be limitations in distinguishing between objects moving in different directions at the same Doppler velocity, and at the same distance from the measurement subject.

### SUMMARY

Example embodiments of the present inventive concepts provide electronic devices that increase the types of identifiable motions by utilizing the intensity distribution of a tone signal according to a Doppler velocity.

According to some example embodiments, an electronic device includes a radar antenna configured to transmit and receive a radio frequency (RF) signal, and a processor configured to identify a motion of a target object based on a signal received through the radar antenna. The processor further configured to obtain a Doppler velocity of the target object, and power of a tone signal obtained in an operation of detecting the target object during a measurement time, obtain a power distribution of the tone signal according to the Doppler velocity, calculate a first correlation value between the power distribution and a first reference distribution corresponding to a first motion of the target object, and a second correlation value between the power distribution and a second reference distribution corresponding to a second motion of the target object, and determine the motion of the target object as the first motion in response to the first correlation value being greater than the second correlation value.

According to some example embodiments, a method of operating an electronic device for identifying a motion of a target object includes obtaining a Doppler velocity of the target object, and power of a tone signal obtained in an operation of detecting the target object during a preset measurement time, obtaining a power distribution of the tone signal according to the Doppler velocity, calculating a first correlation value between the power distribution and a first reference distribution corresponding to a first motion of the target object, and a second correlation value between the power distribution and a second reference distribution corresponding to a second motion of the target object, and determining the motion of the target object as the first motion in response to the first correlation value being greater than the second correlation value.

According to some example embodiments, an electronic device includes a radar antenna configured to transmit a transmission signal and receive a reception signal reflected from a target object, a processor configured to identify a motion of the target object based on the reception signal, and a memory configured to store instructions and operatively connected to the processor. The processor configured to obtain a Doppler velocity of the target object, and power of a tone signal obtained in an operation of detecting the target object during a measurement time, obtain a power distribution of the tone signal according to the Doppler velocity from power values of the tone signal corresponding to each of a plurality of values of the Doppler velocity measured during the measurement time, calculate a first correlation value between the power distribution and a first reference distribution corresponding to a first motion, and a second correlation value between the power distribution and a second reference distribution corresponding to a second motion, and determine the motion of the target object as the first motion in response to the first correlation value being greater than the second correlation value.

### BRIEF DESCRIPTION OF THE FIGURES

The above and other objects and features of the present inventive concepts will become apparent by describing in detail some example embodiments thereof with reference to the accompanying drawings.

FIG. 1A is a block diagram of an electronic device, according to some example embodiments.

FIG. 1B is a block diagram of an electronic device further including a memory, according to some example embodiments.

FIG. 2 is a plan view of a configuration in which an electronic device identifies a target object within a threshold distance, according to some example embodiments.

FIG. 3A illustrates a distance between an electronic device and a target object measured by an electronic device, according to some example embodiments.

FIG. 3B illustrates Doppler velocity of a target object measured by an electronic device, according to some example embodiments.

FIG. 3C illustrates the power of a tone signal measured by an electronic device, according to some example embodiments.

FIG. 4 illustrates a power sum distribution including power values of a tone signal according to Doppler velocity, according to some example embodiments.

FIG. 5 illustrates a power distribution generated by adding power values of a tone signal according to Doppler velocity, according to some example embodiments.

FIG. 6A illustrates a configuration in which an electronic device computes a correlation value between a power distribution and a first reference distribution, according to some example embodiments.

FIG. 6B illustrates a configuration in which an electronic device computes a correlation value between a power distribution and a second reference distribution, according to some example embodiments.

FIG. 7 is a flowchart illustrating a method, in which an electronic device identifies a motion of a target object, according to some example embodiments.

FIG. 8 is a flowchart illustrating a method, in which an electronic device identifies a target object within a threshold distance, according to some example embodiments.

FIG. 9 is a flowchart illustrating a method, in which an electronic device obtains the power distribution of a tone signal, according to some example embodiments.

FIG. 10 is a block diagram illustrating an electronic device, according to another example embodiment.

FIG. 11 is a block diagram illustrating an Internet of Things (IoT) device including an electronic device, according to some example embodiments.

FIG. 12 is a block diagram showing a mobile terminal, to which an electronic device is applied, according to some example embodiments.

### DETAILED DESCRIPTION

Hereinafter, some example embodiments of the present inventive concepts will be described in detail and clearly to such an extent that an ordinary one in the art easily implements the present disclosure.

In the present inventive concepts, expressions such as “first,” “second,” and the like may refer to various components regardless of order and/or importance, and are only used to distinguish one component from another and do not limit the order or importance of the components.

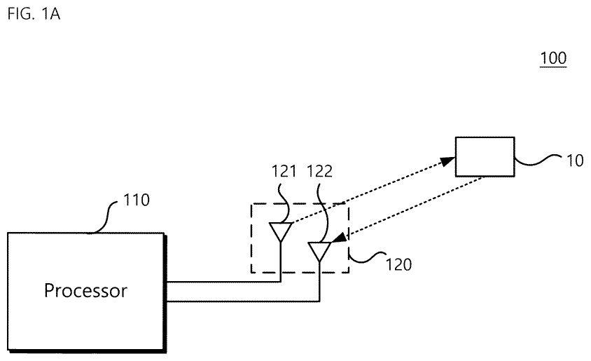

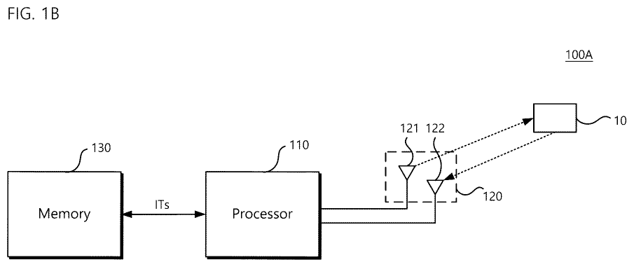

FIG. 1A is a block diagram of an electronic device, according to some example embodiments. FIG. 1B is a block diagram of an electronic device further including a memory, according to an embodiment.

Referring to FIG. 1A, an electronic device 100 according to some example embodiments, may include a processor 110 and a radar antenna 120.

The electronic device 100 according to various example embodiments may be various types of devices. The electronic device 100 may include, for example, a portable communication device (e.g., a smartphone), a computer device, a portable multimedia device, home appliances, a mobile medical appliance, a kiosk, a vehicle, and/or a wearable device. The electronic device 100 according to some example embodiments may not be limited to the above-described devices.

According to some example embodiments, the electronic device 100 may include the radar antenna 120 for transmitting and receiving radio frequency (RF) signals. For example, the electronic device 100 may transmit and/or receive an RF signal of a specified or alternatively, a desired frequency band via the radar antenna 120.

According to some example embodiments, the radar antenna 120 may include a first antenna element 121 and a second antenna element 122.

For example, the first antenna element 121 of the radar antenna 120 may transmit and/or send a transmission signal. For example, the first antenna element 121 may output the transmission signal at a frequency of about 2.4 GHz, but example embodiments are not limited thereto. In some example embodiments, the first antenna element 121 of the radar antenna 120 may transmit, send, and/or output the transmission signal at a frequency of at least 1 GHz to at least 110 GHz.

The second antenna element 122 of the radar antenna 120 may receive a reflected signal from a target object 10. For example, the second antenna element 122 may receive a signal that is output from the first antenna element 121 and then is reflected by the target object 10. In other words, in some example embodiments, the first antenna element 121 of the radar antenna 120 may transmit and/or send a transmission signal and the second antenna element 122 of the radar antenna 120 may receive a signal (e.g., a reflection signal) that is reflected from the target object 10.

According to some example embodiments, the target object 10 may be a part of a body (e.g., a hand), but example embodiments are not limited thereto. For example, the target object 10 may be a vehicle, a robot, and/or any other type of device.

Referring to the above-described example embodiments, the radar antenna 120 may include the first antenna element 121 for transmitting and/or sending one signal (e.g., a first signal, a transmission signal, etc.) and the second antenna element 122 for receiving one signal (e.g., a second signal, a reception signal, etc.). For example, the radar antenna 120 according to some example embodiments may be referred to as a “1T1R antenna”.

Still referring to FIG. 1A, the electronic device 100 may include the processor 110, and the processor 110 may be electrically connected to the radar antenna 120.

For example, the processor 110 may execute software (or a program) to control at least one other component of the electronic device 100 and may process and calculate various types of data. The processor 110 may include a central processing device or microprocessor, and may control the overall operation of the electronic device 100 according to various example embodiments described herein. Accordingly, the operations performed by the electronic device 100 may be understood as being performed under the control of the processor 110.

Referring to FIG. 1B, an electronic device 100A according to some example embodiments, may further include a memory 130 operatively connected to the processor 110. Here, the electronic device 100A illustrated in FIG. 1B may be understood as an example of the electronic device 100 illustrated in FIG. 1A that further includes the memory 130.

The memory 130 according to some example embodiments may include a hardware component for storing data and/or instructions ITs that are to be input and/or output to the processor 110. For example, the memory 130 may include a volatile memory such as a random-access memory (RAM), and/or a non-volatile memory such as a read-only memory (ROM). For example, the volatile memory may include at least one of a dynamic RAM (DRAM), a static RAM (SRAM), a cache RAM, and/or a pseudo SRAM (PSRAM). For example, the non-volatile memory includes at least one of a programmable ROM (PROM), an erasable PROM (EPROM), an electrically erasable PROM (EEPROM), a flash memory, a hard disk, a compact disk, and/or an embedded multi-media card (eMMC).

According to some example embodiments, the memory 130 may store the one or more instructions ITs indicating calculations and/or operations to be performed on data by the electronic device 100A (or the processor 110). Here, a set of one or more instructions ITs may be referred to as a “firmware”, an “operating system”, a “process”, a “routine”, a “sub-routine”, and/or an “application”. For example, when a set of a plurality of instructions distributed in the form of an operating system, firmware, drivers, and/or applications are executed, the electronic device 100A (or the processor 110) may perform at least one of operations to be described later according to some example embodiments.

For convenience of description, example embodiments according to the present inventive concepts are described below as being implemented by the electronic device 100 illustrated in FIG. 1A.

Referring to FIG. 1A, according to some example embodiments, the processor 110 may include an algorithm for identifying the motion of the target object 10 based on a signal received via the radar antenna 120. For example, the algorithm may be a software code programmed inside the processor 110. In at least one example embodiment, the algorithm may be a hard code, which is hard-coded inside the processor 110, but example embodiments are not limited thereto.

The processor 110 may identify the type of motion of the target object 10 based on parameters of the signal received from the radar antenna 120 according to the algorithm.

According to some example embodiments, the processor 110 may identify the target object 10.

For example, the processor 110 may determine whether the target object 10 is present within a region of interest (ROI) of the electronic device 100, based on the signal received via the radar antenna 120.

For example, the processor 110 may determine a distance between the electronic device 100 and the target object 10 based on the signal received via the radar antenna 120. In some example embodiments, when the distance between the electronic device 100 and the target object 10 is less than or equal to a threshold distance, the processor 110 may determine that the target object 10 is present within the ROI of the electronic device 100.

Furthermore, the processor 110 may determine the Doppler velocity of the target object 10 based on the signal received through the radar antenna 120.

For example, the processor 110 may determine the Doppler velocity of the target object 10 during a preset measurement time. In some example embodiments, the processor 110 may sample the Doppler velocity of the target object 10 multiple times during the measurement time. In at least one example embodiment, the processor 110 may determine the Doppler velocity of the target object 10 during a measurement time period (e.g., a measurement time window). The measurement time period (e.g., the measurement time window) may be a preset amount (e.g., length) of time and/or a desired amount (e.g., length) of time. During the measurement time period (e.g., the measurement time window), the processor 110 may sample the Doppler velocity of the target object 10 multiple times. For example, over the measurement time, the Doppler velocity may be a time-varying signal where at any one instant of time the Doppler velocity may be represented as a single value such that the Doppler velocity determined during the measurement time may be a plurality of values.

According to various example embodiments, the Doppler velocity of the target object 10 may be referred to as a speed at which the target object 10 moves in a direction from the electronic device 100 to the target object 10. The Doppler velocity of the target object 10 may be understood as radial velocity. For example, the Doppler velocity of the target object 10 may be referred to as the speed at which the target object 10 moves toward or away from the electronic device 100 along a line of sight of the electronic device 100, where the Doppler velocity of the target object 10 is the radial velocity (e.g., the radial component).

In other words, the processor 110 may determine the Doppler velocity corresponding to the speed at which the target object 10 is moving away from or closer to the electronic device 100 based on the signal received through the radar antenna 120.

In some example embodiments, the processor 110 may determine a power of a tone signal during the measurement time. For example, the processor 110 may determine the power of the tone signal based on a transmission signal transmitted through the radar antenna 120 and a reception signal received through the radar antenna 120.

Here, the tone signal according to some example embodiments may be referred to as a signal corresponding to a difference between a frequency of a transmission signal transmitted through the first antenna element 121 and a frequency of a reception signal received through the second antenna element 122.

For example, the processor 110 may determine the power of the tone signal corresponding to a frequency difference between the reception signal and the transmission signal for detecting the target object 10 through the radar antenna 120.

In at least one example embodiment, the power of the tone signal may be composed of normalized values. For example, the processor 110 may normalize power values of the tone signal such that the measured power of the tone signal has a value within a preset or alternatively, a desired range (e.g., 0 to 1).

Accordingly, the processor 110 according to various example embodiments may reduce and/or minimize the impact of differences in characteristics (e.g., size, humidity, and distance) between different target objects in an operation of identifying the motion of each target object.

According to some example embodiments, the processor 110 may obtain the power distribution of a tone signal according to the Doppler velocity.

The processor 110 may identify power values of a tone signal corresponding to each value of the Doppler velocity acquired during a measurement time. For example, the processor 110 may identify the power value of at least one tone signal corresponding to one of values of the Doppler velocity acquired during the measurement time. For example, the processor 110 may identify a first power value and a second power value corresponding to a first Doppler velocity value among the Doppler velocity values acquired during the measurement time.

For example, the processor 110 may obtain the distribution of power values of the tone signal according to the values of the Doppler velocity.

According to various example embodiments, the values of the Doppler velocity may be understood as normalized values. For example, the processor 110 may normalize the Doppler velocity values by dividing each of the Doppler velocity values, which are acquired during the measurement time, by the largest value among the Doppler velocity values acquired during the measurement time.

In this way, the processor 110 according to some example embodiments of the present inventive concepts may reduce the impact of an operation of identifying the motion of each target object by using a speed difference between different target objects.

Furthermore, the processor 110 may compare the power distribution of the tone signal according to the Doppler velocity with each of a first reference distribution and a second reference distribution corresponding to different motions.

For example, the first reference distribution may correspond to a first motion of the target object 10. In more detail, when the target object 10 performs the first motion, the first reference distribution may be referred to as the power distribution of the tone signal according to the acquired Doppler velocity. The second reference distribution may correspond to a second motion of the target object 10. For example, when the target object 10 performs the second motion, the second reference distribution may be referred to as the power distribution of the tone signal according to the acquired Doppler velocity.

herein at least one example embodiment, the first motion and the second motion may be understood as motions in which the target object 10 proceeds in different directions at the same distance from the electronic device 100 and with the same Doppler velocity.

For example, the first motion may be referred to as a motion in which the target object 10 moves in a first direction while a constant distance from the electronic device 100 is maintained. For example, the second motion may be referred to as a motion in which the target object 10 moves in a second direction distinct from the first direction while a constant distance from the electronic device 100 is maintained.

The processor 110 may compute the degree of correlation between the power distribution of a tone signal according to the Doppler velocity and the first reference distribution. For example, the processor 110 may compute a first correlation value between the power distribution and the first reference distribution.

For example, the processor 110 may compute the first correlation value by dividing the inner product between a measurement vector extracted from the power distribution and a first reference vector extracted from the first reference distribution by the absolute value of the first reference vector.

Moreover, the processor 110 may compute the degree of correlation between the power distribution of a tone signal according to the Doppler velocity and the second reference distribution. For example, the processor 110 may compute a second correlation value between the power distribution and the second reference distribution.

For example, the processor 110 may compute the second correlation value by dividing the inner product between the measurement vector extracted from the power distribution and a second reference vector extracted from the second reference distribution by the absolute value of the second reference vector.

Furthermore, when the first correlation value is greater than the second correlation value, the processor 110 may determine the motion of the target object 10 as the first motion.

In other words, when the power distribution of the tone signal measured according to the motion of the target object 10 is relatively more similar to the first reference distribution than the second reference distribution, the processor 110 may determine the motion of the target object 10 as the first motion.

Referring to the above-described example embodiments, the processor 110 according to some example embodiments may obtain the Doppler velocity of the target object 10, and the power of the tone signal obtained in a process of detecting the target object 10 based on the signal received through the radar antenna 120.

Furthermore, the processor 110 may obtain the power distribution of a tone signal according to the Doppler velocity.

In some example embodiments, the processor 110 may identify the type of motion performed by the target object 10 by calculating a correlation value (or similarity) between the power distribution of the tone signal according to the Doppler velocity, and reference distributions respectively corresponding to the different motions. Here, the different motions may be understood as operations having the same Doppler velocity and the same distance between the electronic device 100 and the target object 10.

For example, the processor 110 may distinguish between motions of the target object 10 performed in different directions with the same distance and the same Doppler velocity with respect to the electronic device 100.

In this way, the electronic device 100 according to some example embodiments of the present inventive concepts may increase the types of motions of the target object 10 identifiable through the radar antenna 120.

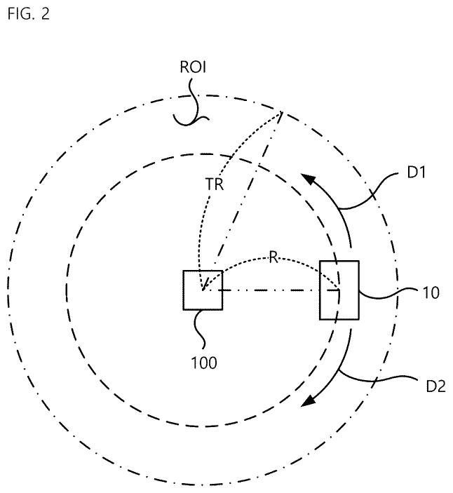

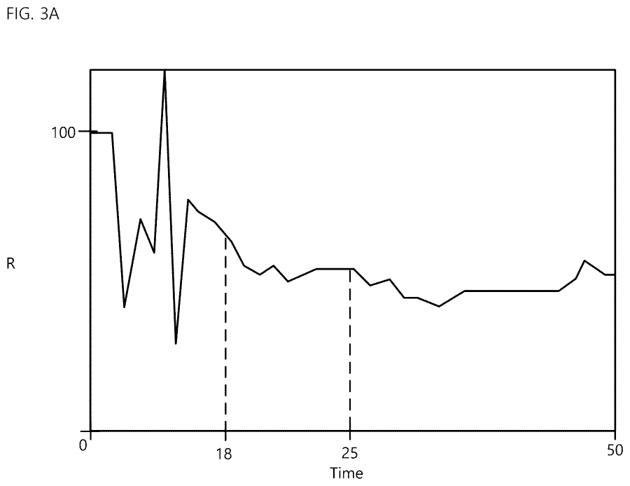

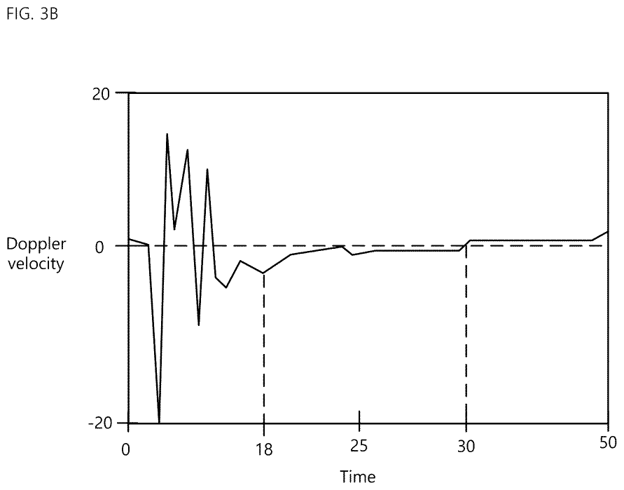

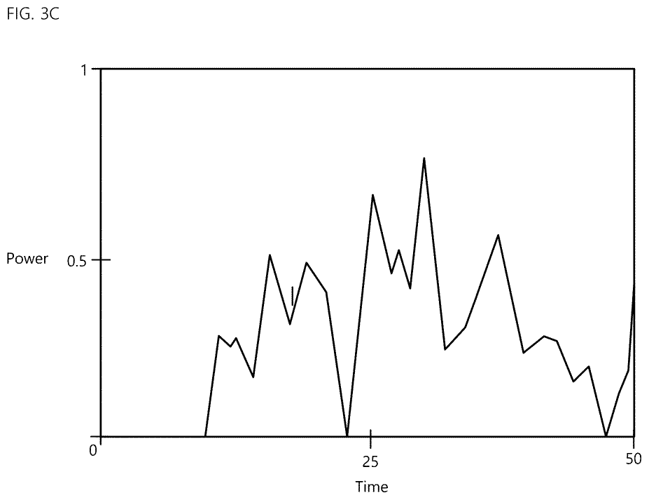

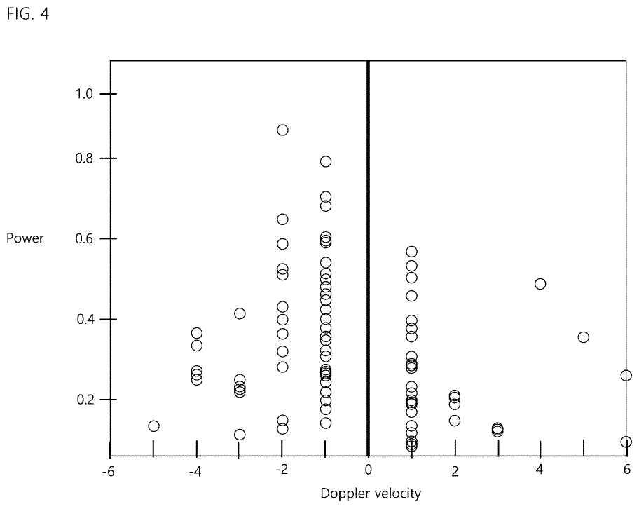

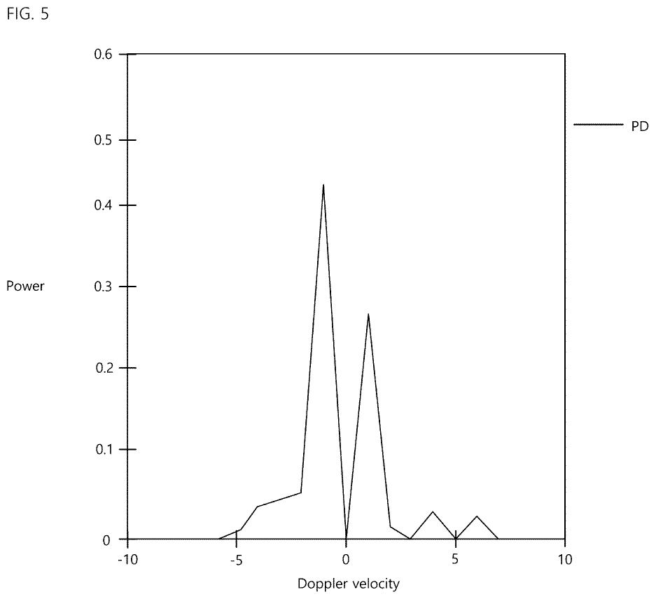

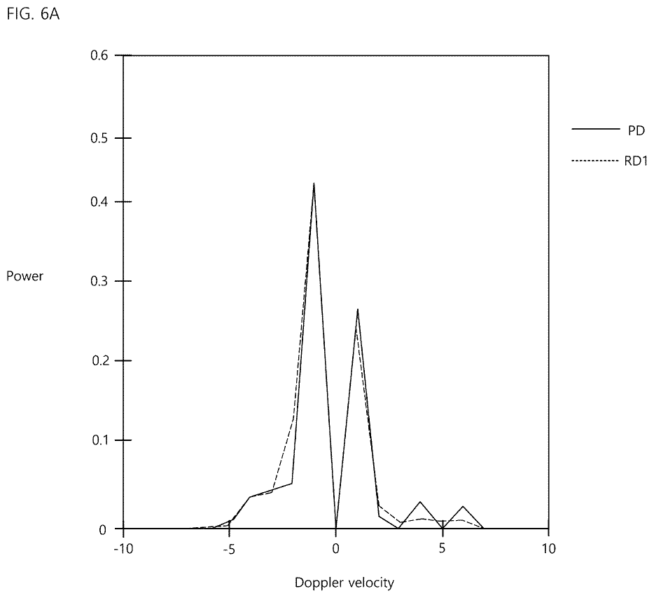

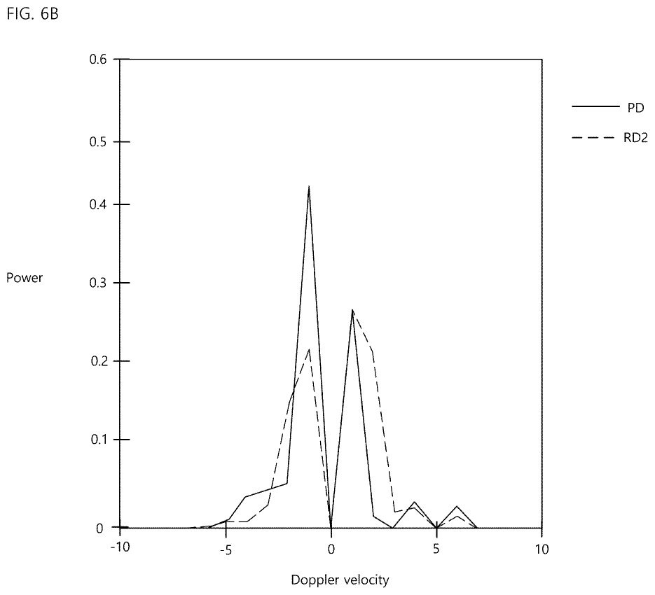

FIG. 2 is a plan view of a configuration in which an electronic device identifies a target object within a threshold distance, according to some example embodiments. FIG. 3A illustrates a distance between an electronic device and a target object measured by an electronic device, according to some example embodiments. FIG. 3B illustrates Doppler velocity of a target object measured by an electronic device, according to some example embodiments. FIG. 3C illustrates the power of a tone signal measured by an electronic device, according to some example embodiments. FIG. 4 illustrates a power sum distribution including power values of a tone signal according to Doppler velocity, according to some example embodiments. FIG. 5 illustrates a power distribution generated by adding power values of a tone signal according to Doppler velocity, according to some example embodiments. FIG. 6A illustrates a configuration in which an electronic device computes a correlation value between a power distribution and a first reference distribution, according to some example embodiments. FIG. 6B illustrates a configuration in which an electronic device computes a correlation value between a power distribution and a second reference distribution, according to some example embodiments.

Referring to FIGS. 2 to 6B together, the electronic device 100 (or the processor 110) according to some example embodiments may identify a type of motion performed by the target object 10.

For example, the processor 110 may distinguish and identify motions of the target object 10 that have a same distance and a same Doppler velocity with respect to the target object 10 and are performed in different directions.

According to some example embodiments, the processor 110 may identify a type of motion performed by the target object 10 by using the power distribution of a tone signal acquired in the process of detecting the target object 10 according to the Doppler velocity of the target object 10.

According to some example embodiments, the processor 110 may identify the target object 10.

Referring to FIGS. 2 and 3A together, the processor 110 may determine a distance ‘R’ between the electronic device 100 and the target object 10 based on the signal received via the radar antenna 120.

For example, the processor 110 may determine the distance ‘R’ between the electronic device 100 and the target object 10 based on a period of from a point in time when a signal is transmitted via the first antenna element 121 to a point in time when a signal is received via the second antenna element 122.

Referring to FIG. 2, the processor 110 may determine whether the target object 10 is present within the ROI of the electronic device 100, based on a signal received via the radar antenna 120.

For example, when the distance ‘R’ between the electronic device 100 and the target object 10 is less than or equal to a threshold distance TR, the processor 110 may determine that the target object 10 is present within the ROI of the electronic device 100.

Also, referring to FIG. 3A, for example, the processor 110 may determine that the target object 10 performs an operation of moving closer to the electronic device 100 for a period of from 18 seconds to 25 seconds.

Furthermore, referring to FIG. 3B, the processor 110 according to some example embodiments may determine the Doppler velocity of the target object 10. For example, the processor 110 may determine the Doppler velocity of the target object 10 in response to the target object 10 being determined as being present within the ROI. Here, for example, the measurement unit of the Doppler velocity may be referred to as “m/s”, but example embodiments are not limited thereto.

Moreover, in some example embodiments, the Doppler velocity of the target object 10 may be referred to as a speed at which the target object 10 moves in a direction from the electronic device 100 to the target object 10.

For example, the processor 110 may determine the Doppler velocity corresponding to the speed at which the target object 10 is moving away from or closer to the electronic device 100 based on the signal received through the radar antenna 120.

For example, referring to FIG. 3B, the processor 110 according to some example embodiments may determine that the target object 10 performs an operation in which the speed of the target object 10 decreases as it approaches the electronic device 100 in a direction toward the electronic device 100 for a period of from 18 seconds to 30 seconds.

In addition, the processor 110 according to some example embodiments may identify the target object 10 within an ROI through a constant false alarm rate (CFAR) for a Doppler velocity of the target object 10 and/or a distance ‘R’ between the target object 10 and the electronic device 100.

For example, the processor 110 may identify an object within the ROI as the target object 10 through the CFAR of the Doppler velocity of the target object 10.

Referring to FIG. 3C, the processor 110 according to some example embodiments may determine the power of a tone signal during a measurement time.

For example, the processor 110 may determine the power of a tone signal based on a transmission signal transmitted through the radar antenna 120 and a reception signal received through the radar antenna 120.

Here, the tone signal may be referred to as a signal corresponding to a difference between the frequency of the transmission signal transmitted through the radar antenna 120 and the frequency of the reception signal received through the radar antenna 120.

For example, the processor 110 may determine the power of the tone signal corresponding to the frequency difference between the reception signal and the transmission signal for detecting the target object 10 through the radar antenna 120.

In some example embodiments, the power of the tone signal may be composed of normalized values. For example, referring to FIG. 3C, the processor 110 may normalize power values of the tone signal such that the measured power of the tone signal has a value within a range of 0 to 1.

Accordingly, the processor 110 according to some example embodiments may reduce and/or minimize the impact of differences in characteristics (e.g., a size, humidity, and a distance) between different target objects in an operation of identifying the motion of each target object

Furthermore, referring to FIG. 4, the processor 110 according to some example embodiments may identify power values of a tone signal corresponding to each value of the Doppler velocity acquired during a measurement time.

For example, the processor 110 may identify the power value of at least one tone signal corresponding to one of values of the Doppler velocity acquired during the measurement time. For example, the processor 110 may identify a plurality of power values corresponding to a value of −2 among the Doppler velocity values acquired during the measurement time.

For example, the processor 110 may obtain the distribution of power values of the tone signal according to the values of the Doppler velocity.

In some example embodiments, the values of the Doppler velocity may be understood as normalized values. For example, the processor 110 may normalize the Doppler velocity values by dividing each of the Doppler velocity values, which are acquired during the measurement time, by the largest value among the Doppler velocity values acquired during the measurement time. Accordingly, referring to FIG. 4, the values of Doppler velocity may have values within a specified range (e.g., −6 to 6).

In this way, the processor 110 according to some example embodiments of the present inventive concepts may reduce the impact of an operation of identifying the motion of each target object by using a speed difference between different target objects.

Referring to FIGS. 4 and 5 together, the processor 110 according to some example embodiments may obtain a power distribution PD of a tone signal according to a Doppler velocity.

For example, the processor 110 may obtain a power sum distribution of tone signals according to the Doppler velocity by adding the power values of the tone signal corresponding to each of values of the Doppler velocity.

For example, the processor 110 may obtain the sum of the power values of the tone signal at a point in time when the Doppler velocity of the target object 10 is “3”, by adding the power values of the tone signal corresponding to a value of “3” among values of the Doppler velocity.

For example, the processor 110 may obtain the power sum distribution including the sum of power values of the tone signal corresponding to each of the values of the Doppler velocity.

Moreover, here, the processor 110 may obtain the power distribution PD by normalizing the power sum distribution such that the sum of the squares of the power values of the tone signal corresponding to each of the values of the Doppler velocity is less than or equal to a specified value (e.g., “1”).

Accordingly, the processor 110 according to some example embodiments of the present inventive concepts may reduce and/or minimize the impact of an operation of identifying the motion of each target object by using a difference in the absolute value of the power of a tone signal caused by the difference in the characteristics (e.g., reflectivity) and/or measurement environments (e.g., the number of samplings or a sampling frequency) between different target objects. For example, the processor 110 according to some example embodiments may reduce and/or minimize the impact of an operation of identifying the motion of each target object by using differences in the absolute value of the power of a tone signal, the differences arising and/or being caused by variations in characteristics (e.g., reflectivity) and/or measurement environments (e.g., the number of samplings or a sampling frequency).

Furthermore, referring to FIGS. 6A and 6B together, the processor 110 may compare the power distribution PD of the tone signal according to the Doppler velocity with each of a first reference distribution RD1 and a second reference distribution RD2 corresponding to different motions.

The first reference distribution RD1 shown in FIG. 6A may correspond to the first motion of the target object 10. For example, when the target object 10 performs the first motion, the first reference distribution RD1 may be referred to as the power distribution of the tone signal according to the acquired Doppler velocity.

The second reference distribution RD2 shown in FIG. 6B may correspond to the second motion of the target object 10. For example, when the target object 10 performs the second motion, the second reference distribution RD2 may be referred to as the power distribution of the tone signal according to the acquired Doppler velocity.

According to some example embodiments, the first motion and the second motion may be understood as motions in which the target object 10 proceeds, moves, and/or travels in different directions at the same distance from the electronic device 100 and with the same Doppler velocity. For example, the first motion may be referred to as a motion in which the target object 10 moves in a first direction while a constant distance from the electronic device 100 is maintained. The second motion may be referred to as a motion in which the target object 10 moves in a second direction distinct from the first direction while a constant distance from the electronic device 100 is maintained.

The processor 110 may compute the degree of correlation between the power distribution PD of a tone signal according to the Doppler velocity and the first reference distribution RD1. For example, the processor 110 may compute a first correlation value CV1 between the power distribution PD and the first reference distribution RD1.

For example, the processor 110 may compute the first correlation value CV1 by dividing the inner product between a measurement vector ‘Z’ extracted from the power distribution PD and a first reference vector x1 extracted from the first reference distribution RD1 by the absolute value of the first reference vector x1. Here, the operation in which the processor 110 obtains the first correlation value CV1 may be referenced by Equation 1 below.

$$CV 1 = \frac{x {1}^{T} Z}{‖ x 1 ‖} \qquad [ Equation 1 ]$$

Here, x1^{T} may be understood as a value of the transformed rows and columns of the first reference vector x1 for the inner product operation.

In some example embodiments, the processor 110 may compute the degree of correlation between the power distribution PD of a tone signal according to the Doppler velocity and the second reference distribution RD2. For example, the processor 110 may compute a second correlation value CV2 between the power distribution PD and the second reference distribution RD2.

For example, the processor 110 may compute the second correlation value CV2 by dividing the inner product between the measurement vector ‘Z’ extracted from the power distribution PD and a second reference vector x2 extracted from the second reference distribution RD2 by the absolute value of the second reference vector x2. Here, the operation in which the processor 110 obtains the second correlation value CV2 may be referenced by Equation 2 below.

$$CV 2 = \frac{x {2}^{T} Z}{‖ x 2 ‖} \qquad [ Equation 2 ]$$

Here, x2^{T} may be understood as a value of the transformed rows and columns of the second reference vector x2 for the inner product operation.

According to some example embodiments, when the first correlation value CV1 is greater than the second correlation value CV2, the processor 110 may determine the motion of the target object 10 as the first motion. For example, when the first correlation value CV1 is greater than the second correlation value CV2, the processor 110 may determine the motion of the target object 10 as the first motion. In yet another example, when the first correlation value CV1 is greater than or equal to the second correlation value CV2, the processor 110 may determine the motion of the target object 10 as the first motion.

According to another example embodiment, when the first correlation value CV1 is less than the second correlation value CV2, the processor 110 may determine the motion of the target object 10 as the second motion. For example, when the first correlation value CV1 is less than the second correlation value CV2, the processor 110 may determine the motion of the target object 10 as the second motion. In yet another example, when the first correlation value CV1 is less than or equal to the second correlation value CV2, the processor 110 may determine the motion of the target object 10 as the second motion.

Referring to FIGS. 6A and 6B together, the processor 110 according to some example embodiments may determine the motion of the target object 10 as the first motion in response to determining that the power distribution PD is relatively more similar to a first reference distribution PD1 than to a second reference distribution PD2.

For example, the processor 110 may determine that the motion of the target object 10 corresponds to a motion corresponding to a reference distribution, which is relatively more similar to the power distribution PD, from among the reference distributions RD1 and RD2 corresponding to different motions.

Referring to the above-described configurations, the processor 110 according to some example embodiments may obtain the Doppler velocity of the target object 10, and the power of the tone signal obtained in a process of identifying the target object 10 based on the signal received through the radar antenna 120.

Furthermore, in some example embodiments, the processor 110 may obtain the power distribution PD of a tone signal according to the Doppler velocity.

Moreover, in some example embodiments, the processor 110 may identify the type of motion performed by the target object 10 by calculating the correlation value CV1 or CV2 between the power distribution PD of the tone signal according to the Doppler velocity, and the reference distributions RD1 and RD2 respectively corresponding to the different motions. For example, the different motions may be understood as operations having the same Doppler velocity and the same distance between the electronic device 100 and the target object 10.

For example, the processor 110 may distinguish between motions of the target object 10 performed in different directions with the same distance and the same Doppler velocity with respect to the electronic device 100.

In this way, the electronic device 100 according to some example embodiments of the present inventive concepts may increase the types of motions of the target object 10 identifiable through the radar antenna 120.

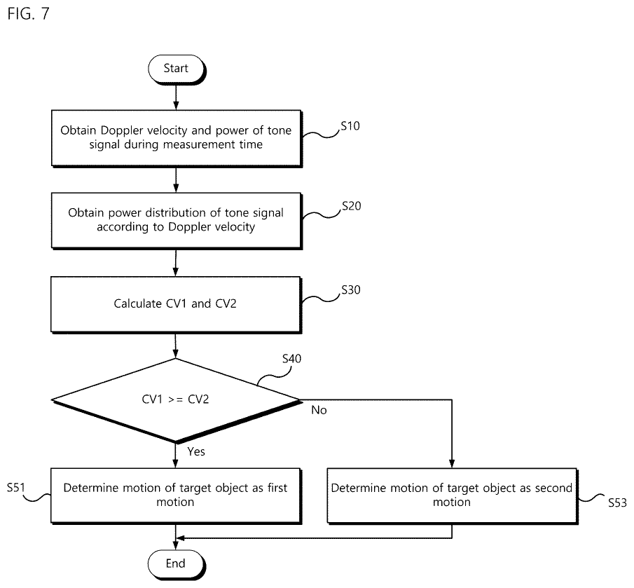

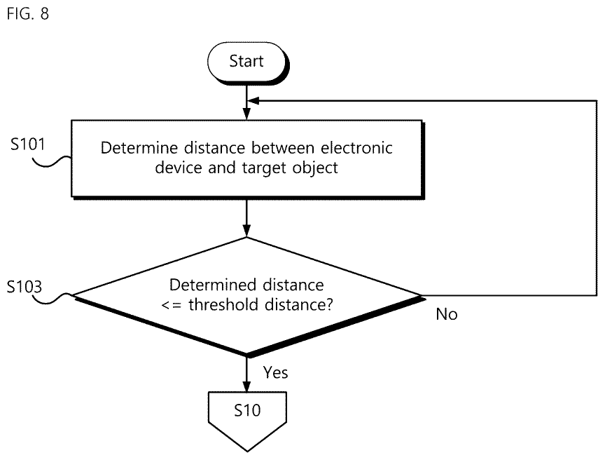

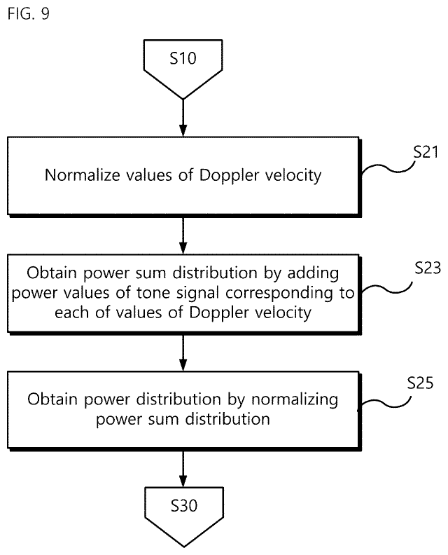

FIG. 7 is a flowchart illustrating a method, in which an electronic device identifies a motion of a target object, according to some example embodiments. FIG. 8 is a flowchart illustrating a method, in which an electronic device identifies a target object within a threshold distance, according to some example embodiments. FIG. 9 is a flowchart illustrating a method, in which an electronic device obtains the power distribution of a tone signal, according to some example embodiments.

Referring to FIG. 7, the electronic device 100 (or the processor 110) according to some example embodiments may identify the motion of the target object 10 based on the power distribution of a tone signal acquired in a process of detecting the target object 10.

In operation S10, the processor 110 according to some example embodiments may obtain a Doppler velocity of the target object 10 and the power of the tone signal during a measurement time.

For example, the processor 110 may determine the Doppler velocity of the target object 10 based on a signal received through the radar antenna 120.

The processor 110 may determine the Doppler velocity of the target object 10 during a preset or alternatively, a desired measurement time. For example, the processor 110 may sample the Doppler velocity of the target object 10 multiple times during the measurement time.

For example, the Doppler velocity of the target object 10 may be referred to as a speed at which the target object 10 moves in a direction from the electronic device 100 to the target object 10. For example, the Doppler velocity of the target object 10 may be understood as radial velocity.

In other words, the processor 110 may determine the Doppler velocity corresponding to the speed at which the target object 10 is moving away from or closer to the electronic device 100 based on the signal received through the radar antenna 120.

In some example embodiments, the processor 110 may determine the power of the tone signal during the measurement time. For example, the processor 110 may determine the power of a tone signal based on a transmission signal transmitted through the radar antenna 120 and a reception signal received through the radar antenna 120.

Here, the tone signal according to some example embodiments may be referred to as a signal corresponding to a difference between a frequency of a transmission signal transmitted through the first antenna element 121 and a frequency of a reception signal received through the second antenna element 122.

For example, the processor 110 may determine the power of the tone signal corresponding to a frequency difference between the reception signal and the transmission signal for detecting the target object 10 through the radar antenna 120.

In some example embodiments, the power of the tone signal here may be composed of normalized values. For example, the processor 110 may normalize power values of the tone signal such that the measured power of the tone signal has a value within a preset or alternatively, a desired range (e.g., 0 to 1).

In this way, the processor 110 according to some example embodiments of the present inventive concepts may reduce the impact of an operation of identifying the motion of each target object by using a difference in characteristics (e.g., a size, humidity, and a distance) between different target objects.

Referring to FIG. 8, the processor 110 may determine whether the target object 10 is present within a ROI of the electronic device 100, based on a signal received via the radar antenna 120. For example, the processor 110 may determine whether the target object 10 is present within the ROI of the electronic device 100 based on a signal received via the radar antenna 120 prior to obtaining the Doppler velocity and power of the tone signal during measurement time at S10 of FIG. 7.

Still referring to FIG. 8, in operation S101, the processor 110 according to some example embodiments may determine a distance between the electronic device 100 and the target object 10 based on the signal received via the radar antenna 120.

For example, the processor 110 may determine the distance ‘R’ between the electronic device 100 and the target object 10 based on a period of time from a point in time when a signal is transmitted via the first antenna element 121 to a point in time when a signal is received via the second antenna element 122. For example, the processor 110 may determine the distance ‘R’ between the electronic device 100 and the target object 10 based on an elapsed amount of time from when a transmission signal is transmitted via the first antenna element 121 to when a reception signal is received via the send antenna element 122.

In operation S103, the processor 110 according to some example embodiments may determine whether the distance ‘R’ between the electronic device 100 and the target object 10 is less than or equal to a threshold distance TR.

In response to a determination that the determined distance ‘R’ between the electronic device 100 and the target object 10 is less than or equal to the threshold distance TR, “Yes” at operation S103, the processor 110 may obtain the Doppler velocity of the target object 10 and the power of the tone signal at operation S10 of FIG. 7. In response to a determination that the determined distance ‘R’ between the electronic device 100 and the target 10 is not less than or equal to the threshold distance TR, “No” at operation S103, the processor returns to operation S101 and proceeds to perform the operations discussed herein.

The processor 110, according to some example embodiments, may identify the target object 10 within the ROI through a constant false alarm rate (CFAR) for at least part of the Doppler velocity of the target object 10 and the power of the tone signal.

For example, the processor 110 may identify a corresponding object as the target object 10 in response to the Doppler velocity measured from the object within the ROI exceeding a threshold value set by the CFAR.

Referring back to FIG. 7, in operation S20, the processor 110 according to some example embodiments may obtain the power distribution PD of a tone signal according to the Doppler velocity.

According to some example embodiments, the processor 110 may identify power values of a tone signal corresponding to each value of the Doppler velocity acquired during the measurement time.

For example, the processor 110 may identify the power value of at least one tone signal corresponding to one of values of the Doppler velocity acquired during the measurement time.

For example, referring to FIGS. 7 and 9 together, the processor 110 according to some example embodiments may obtain the power distribution PD of the tone signal according to the Doppler velocity based on a sum of the power values of the tone signal corresponding to each of the values of the Doppler velocity.

In operation S21, the processor 110 according to some example embodiments may normalize the values of the Doppler velocity.

For example, the processor 110 may normalize the Doppler velocity values by dividing each of the Doppler velocity values, which are acquired during the measurement time, by a largest value among the Doppler velocity values acquired during the measurement time.

In operation S23, the processor 110 may obtain a power sum distribution of tone signals according to the Doppler velocity by adding the power values of the tone signal corresponding to each of the values of the Doppler velocity.

For example, the processor 110 may obtain the sum of the power values of the tone signal at a point in time when the Doppler velocity of the target object 10 is “3”, by adding the power values of the tone signal corresponding to a value of “3” among values of the Doppler velocity.

For example, the processor 110 may obtain the power sum distribution including the sum of power values of the tone signal corresponding to each of the values of the Doppler velocity.

In operation S25, the processor 110 according to some example embodiments may obtain the power distribution PD by normalizing the power sum distribution.

For example, the processor 110 may obtain the power distribution PD by normalizing the power sum distribution such that the sum of the squares of the power values of the tone signal corresponding to each of the values of the Doppler velocity is less than or equal to a specified or alternatively, a desired value (e.g., “1”).

Accordingly, the processor 110 according to some example embodiments of the present inventive concepts may reduce the impact of an operation of identifying the motion of each target object by using a speed difference between different target objects.

Through the above-described configurations, the processor 110 according to some example embodiments may obtain the distribution of power values of the tone signal according to the values of the Doppler velocity.

Referring back to FIG. 7, in operation S30, the processor 110 according to some example embodiments may calculate the first correlation value CV1 and the second correlation value CV2.

For example, the processor 110 may calculate the first correlation value CV1 between the power distribution PD of the tone signal according to the Doppler velocity and the first reference distribution RD1.

For example, the processor 110 may compute the first correlation value CV1 by dividing the inner product between the measurement vector ‘Z’ extracted from the power distribution PD and the first reference vector x1 extracted from the first reference distribution RD1 by the absolute value of the first reference vector x1.

The first reference distribution RD1 may correspond to the first motion of the target object 10. For example, when the target object 10 performs the first motion, the first reference distribution RD1 may be referred to as the power distribution of the tone signal according to the acquired Doppler velocity.

The processor 110 may compute the second correlation value CV2 between the power distribution PD and the second reference distribution RD2.

For example, the processor 110 may compute the second correlation value CV2 by dividing the inner product between the measurement vector ‘Z’ extracted from the power distribution PD and the second reference vector x2 extracted from the second reference distribution RD2 by the absolute value of the second reference vector x2.

The second reference distribution RD2 may correspond to the second motion of the target object 10. For example, when the target object 10 performs the second motion, the second reference distribution RD2 may be referred to as the power distribution of the tone signal according to the acquired Doppler velocity.

In some example embodiments, the first motion and the second motion may be understood as motions in which the target object 10 proceeds in different directions at the same distance from the electronic device 100 and with the same Doppler velocity. For example, the first motion may be referred to as a motion in which the target object 10 moves in a first direction while a constant distance from the electronic device 100 is maintained. For example, the second motion may be referred to as a motion in which the target object 10 moves in a second direction distinct from the first direction while a constant distance from the electronic device 100 is maintained.

For example, the processor 110 may compare the power distribution PD of the tone signal according to the Doppler velocity with each of the first reference distribution RD1 and the second reference distribution RD2 corresponding to different motions.

In operation S40, the processor 110 according to some example embodiments may compare the magnitudes of the first correlation value CV1 and the second correlation value CV2. For example, in operation S40, the processor 110 determines whether the first correlation value CV1 is greater than or equal to the second correlation value CV2.

In at least one example embodiment, in response to a determination that the first correlation value CV1 is greater than the second correlation value CV2, “Yes” at operation S40, the processor 110 may determine a motion of the target object 10 as a first motion at operation S51.

In at least another example embodiment, in response to a determination that the first correlation value CV1 is greater than the second correlation value CV2, “Yes” at operation S40, the processor 110 may determine the motion of the target object 10 as the first motion at operation S51. In yet another example embodiment, in response to a determination that the first correlation value CV1 is greater than or equal to the second correlation value CV2, “Yes” at operation S40, the processor 110 may determine the motion of the target object 10 as the first motion at operation S51.

In other words, when the power distribution of the tone signal measured according to the motion of the target object 10 is relatively more similar to the first reference distribution RD1 than the second reference distribution RD2, the processor 110 may determine the motion of the target object 10 as the first motion.

Returning to operation S40, in response to a determination that the first correlation value CV1 is less than the second correlation value CV2, “No” at operation S40, the processor 110 may determine the motion of the target object 10 as a second motion at operation S53.

For example, when the first correlation value CV1 is less than the second correlation value CV2, “No” at operation S40, the processor 110 may determine the motion of the target object 10 as the second motion at operation S53. In yet another example, when the first correlation value CV1 is less than or equal to the second correlation value CV2, “No” at operation S40, the processor 110 may determine the motion of the target object 10 as the second motion at operation S53.

Referring to the above-described configurations, the processor 110 according to some example embodiments may obtain the Doppler velocity and the power of the tone signal based on the signal received through the radar antenna 120.

Furthermore, the processor 110 may obtain the power distribution of a tone signal according to the Doppler velocity.

Moreover, in some example embodiments, the processor 110 may identify the type of motion performed by the target object 10 by calculating the correlation value CV1 or CV2 between the power distribution PD of the tone signal according to the Doppler velocity, and reference distributions RD1 and RD2 respectively corresponding to the different motions. Here, the different motions may be understood as operations having the same Doppler velocity and the same distance between the electronic device 100 and the target object 10.

For example, the processor 110 may distinguish between motions of the target object 10 performed in different directions with the same distance and the same Doppler velocity with respect to the electronic device 100.

In this way, the electronic device 100 according to some example embodiments of the present inventive concepts may increase the types of motions of the target object 10 identifiable through the radar antenna 120.

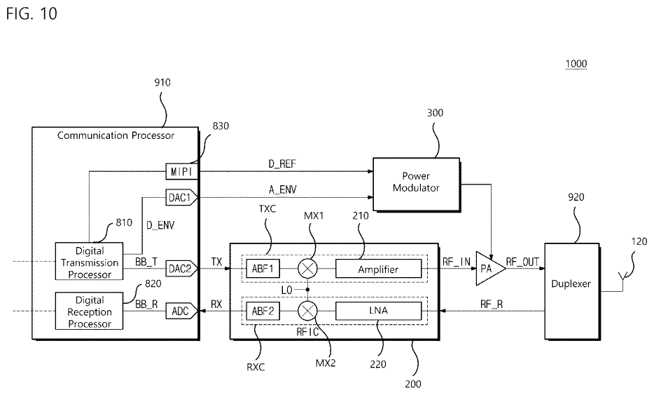

FIG. 10 is a block diagram illustrating an electronic device, according to some example embodiments.

Referring to FIG. 10, the electronic device 1000 may be a wireless communication device. The wireless communication device 1000 according to some example embodiments of the present inventive concepts may include a communication processor 910, an RFIC 200, a power modulator 300, a duplexer 920, and a power amplifier PA. The wireless communication device 1000 may further include the radar antenna 120 described with reference to FIG. 1A.

Here, the wireless communication device 1000 illustrated in FIG. 10 and a configuration thereof may be understood as an example of the electronic device 100 illustrated in FIG. 1A. Accordingly, the same reference numerals are used for components that are the same or substantially the same as the components described with reference to FIG. 1A, and thus duplicate descriptions are not repeated.

Still referring to FIG. 10, the communication processor 910 may process a baseband signal BB_T through a digital transmission processor 810 in compliance with a given communication scheme. The communication processor 910 may process a received baseband signal BB_R through a digital reception processor 820 in compliance with the given communication scheme.

For example, the communication processor 910 may process a signal to be transmitted and/or a received signal in compliance with a communication scheme such as orthogonal frequency division multiplexing (OFDM), orthogonal frequency division multiplexing access (OFDMA), wideband code multiple access (WCDMA), or high speed packet access+ (HSPA+), but example embodiments are not limited thereto. In some example embodiments, the communication processor 910 may process the baseband signal BB_T and/or the received baseband signal BB_R in compliance with various kinds of communication schemes (e.g., various communication schemes to which a technology for modulating and/or demodulating an amplitude and a frequency of the baseband signal BB_T and/or the received baseband signal BB_R is applied).

The communication processor 910 may extract an envelope of the baseband signal BB_T through the digital transmission processor 810 and may generate a digital envelope signal D_ENV based on the extracted envelop. In some example embodiments, the communication processor 910 may generate an average power signal D_REF based on an average power tracking table stored in a memory. Here, the extracted envelope may correspond to an amplitude component (e.g., a magnitude of the I signal and the Q signals) of the baseband signal BB_T.

In some example embodiments, the communication processor 910 may perform digital-to-analog conversion on the baseband signal BB_T and the digital envelope signal D_ENV by using a plurality of digital-to-analog converters DAC1 and DAC2 included therein and may generate a transmit signal TX and an analog envelope signal A_ENV as analog signals. For example, the average power signal D_REF output from the communication processor 910 may be a digital signal. As such, the average power signal D_REF may be provided to a digital-to-analog converter included in the power modulator 300 through a MIPI 830 and may be converted into an analog signal, for example, the reference voltage signal through the digital-to-analog converter included in the power modulator 300. In some example embodiments, the digital-to-analog converters DAC1 and DAC2 included in the communication processor 910 may operate at a speed higher than the digital-to-analog converter included in the power modulator 300.

However, example embodiments of the present inventive concepts are not limited thereto. For example, the communication processor 910 may convert the average power signal D_REF into an analog signal through a digital-to-analog converter included therein and may output the analog signal. For example, the communication processor 910 may provide the average power signal D_REF converted into the analog signal as a reference voltage signal to the power modulator 300.

However, for convenience of description, in some example embodiments of the present inventive concepts, the description will be given as the communication processor 910 provides the average power signal D_REF to the digital-to-analog converter included in the power modulator 300 through the MIPI 830.

In some example embodiments, each of the transmit signal TX and the analog envelope signal A_ENV may be implemented with differential signals including a positive signal and a negative signal.

In some example embodiments, the communication processor 910 may be provided with a receive signal RX being an analog signal from the RFIC 200. In some example embodiments, the communication processor 910 may perform analog-to-digital conversion on the receive signal RX through the analog-to-digital converter ADC included therein and may extract the received baseband signal BB_R as a digital signal. Here, the receive signal RX may be implemented with differential signals including a positive signal and a negative signal.

The RFIC 200 may generate an RF input signal RF_IN by performing frequency up-conversion on the transmit signal TX or may generate the receive signal RX by performing frequency down-conversion on an RF receive signal RF_R. For example, the RFIC 200 may include a transmission circuit TXC for frequency up-conversion, a reception circuit RXC for frequency down-conversion, and a local oscillator LO.

The transmission circuit TXC may include a first analog baseband filter ABF1, a first mixer MX1, and an amplifier 210. For example, the first analog baseband filter ABF1 may include a low pass filter.

The first analog baseband filter ABF1 may filter the transmit signal TX received from the communication processor 910 so as to be provided to the first mixer MX1. For example, the first analog baseband filter ABF1 may filter the transmit signal TX received from the communication processor 910 and provide the filtered transmit signal TX to the first mixer MX1. The first mixer MX1 may perform frequency up-conversion for converting a frequency of the transmit signal TX from a baseband to a high-frequency band through a frequency signal provided by the local oscillator LO. The transmit signal TX obtained through the frequency up-conversion may be provided to the amplifier 210 as the RF input signal RF_IN, and the amplifier 210 may first amplify a power of the RF input signal RF_IN so as to be provided to the power amplifier PA. For example, the amplifier 210 may amplify the power of the RF input signal RF_IN and provide the RF input signal RF_IN to the power amplifier PA.

The power amplifier PA may be supplied with a power supply voltage (e.g., a dynamically variable output voltage) from the power modulator 300, may second amplify a power of the RF input signal RF_IN based on the supplied power supply voltage, and may generate an RF output signal RF_OUT. For example, the power amplifier PA may amplify the power of the RF input signal RF_IN based on the supplied power supply voltage and generate the RF output signal RF_OUT. The power amplifier PA may provide the RF output signal RF_OUT thus generated to the duplexer 920.

The reception circuit RXC may include a second analog baseband filter ABF2, a second mixer MX2, and a low-noise amplifier 220. For example, the second analog baseband filter ABF2 may include a low pass filter.

The low-noise amplifier 220 may amplify the RF receive signal RF_R provided from the duplexer 920 so as to be provided to the second mixer MX2. For example, the low-noise amplifier 220 may amplify the RF receive signal RF_R provided from the duplexer, and may provide the amplified RF receive signal RF_R to the second mixer MX2. The second mixer MX2 may perform frequency down-conversion for converting a frequency of the RF receive signal RF_R from a high-frequency band to a baseband through a frequency signal provided by the local oscillator LO. The RF receive signal RF_R may be provided to the second analog baseband filter ABF2 as the receive signal RX through the above frequency down-conversion, and the second analog baseband filter ABF2 may filter the receive signal RX so as to provide the receive signal RX to the communication processor 910.

The power modulator 300 may generate a modulated output voltage, the level of which varies dynamically, based on the analog envelope signal A_ENV and the average power signal D_REF and may provide the modulated output voltage to the power amplifier PA as the power supply voltage.

For example, the power modulator 300 may be provided with the average power signal D_REF and the analog envelope signal A_ENV from the communication processor 910. The power modulator 300 may be driven in a tracking mode corresponding to one of an envelope tracking (ET) mode and an average power tracking (APT) mode based on the average power signal D_REF and the analog envelope signal A_ENV thus provided and may generate the dynamically variable output voltage. In some example embodiments, the power modulator 300 may supply the generated output voltage to the power amplifier PA as the power supply voltage.

In some example embodiments, when the power supply voltage of a fixed level is applied to the power amplifier PA, power efficiency of the power amplifier PA may decrease. Accordingly, to efficiently manage a power of the power amplifier PA, the power modulator 300 may modulate an input voltage (e.g., a power provided from a battery) based on at least one of the analog envelope signal A_ENV and the average power signal D_REF and may provide the modulated voltage to the power amplifier PA as the power supply voltage.

The wireless communication device 1000 may include the duplexer 920 and the duplexer 920 may be capable of separating a transmission frequency and a reception frequency. For example, the duplexer 920 may separate the RF output signal RF_OUT provided from the power amplifier PA for each frequency band so as to be provided to the corresponding radar antenna 120. In some example embodiments, the duplexer 920 may provide an external signal provided from the radar antenna 120 to the low-noise amplifier 220 of the reception circuit RXC of the RFIC 200. For example, the duplexer 920 may include a front end module with integrated duplexer (FEMiD).

The radar antenna 120 may transmit the RF output signal RF_OUT to the outside or may provide the RF receive signal RF_R received from the outside to the RFIC 200. For example, the radar antenna 120 may be referenced as, but is not limited to, a 1T1R antenna.

In some example embodiments, each of the communication processor 910, the power modulator 300, the RFIC 200, the power amplifier PA, and the duplexer 920 may be implemented with an integrated circuit, a chip, and/or a module. Also, the communication processor 910, the power modulator 300, the RFIC 200, the power amplifier PA, and the duplexer 920 may be together mounted on a printed circuit board (PCB). However, example embodiments of the present inventive concepts are not limited thereto. In some example embodiments, at least a part of the communication processor 910, the power modulator 300, the RFIC 200, the power amplifier PA, and the duplexer 920 may be implemented with a single communication chip.

In some example embodiments, the wireless communication device 1000 illustrated in FIG. 10 may be included in a wireless communication system that uses a cellular network such as 5G, LTE, and/or the like and may also be included in a wireless local area network (WLAN) system or any other wireless communication system. In some example embodiments, a configuration of the wireless communication device 1000 illustrated in FIG. 10 is, but is not limited to, an example embodiment, and may be variously configured in compliance with a communication protocol and/or a communication scheme.

The communication processor 910 illustrated in FIG. 10 may be understood as an example of the processor 110 illustrated in FIG. 1A.

According to some example embodiments, the communication processor 910 may obtain the Doppler velocity of the target object 10 identified within the threshold distance TR from the wireless communication device 1000 based on a signal received through the radar antenna 120. In some example embodiments, the communication processor 910 may obtain the power of the tone signal based on the signals for identifying the target object 10.

Furthermore, the communication processor 910 may obtain the power distribution PD of a tone signal according to the Doppler velocity.

Moreover, the communication processor 910 may identify the type of motion performed by the target object 10 by calculating the correlation value CV1 or CV2 between the power distribution PD of the tone signal according to the Doppler velocity, and reference distributions RD1 and RD2 respectively corresponding to the different motions. Here, the different motions may be understood as operations having the same Doppler velocity and the same distance between the wireless communication device 1000 and the target object 10.

For example, the communication processor 910 may distinguish between motions of the target object 10 performed in different directions with the same distance and the same Doppler velocity with respect to the wireless communication device 1000.

In this way, the wireless communication device 1000 according to some example embodiments of the present inventive concepts may increase the types of motions of the target object 10 identifiable through the radar antenna 120.

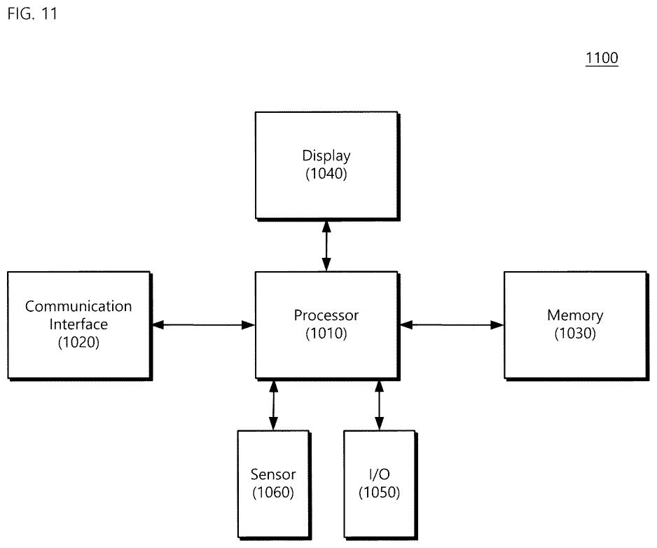

FIG. 11 is a block diagram illustrating an IoT device including an electronic device, according to some example embodiments.

Referring to FIG. 11, an IoT may refer to a network between devices that use wired and/or wireless communication. The IoT device 1100 may include an accessible wired or/and wireless interface (not shown) and may include devices that communicate with at least one or more other devices through the wired or/and wireless interface to transmit and/or receive data. The accessible interface that the IoT device 1100 includes may include a modem communication interface that is accessible to a local area network (LAN), a wireless local area network (WLAN) such as a wireless fidelity (Wi-Fi), a wireless personal area network (WPAN) such as Bluetooth, a wireless universal serial bus (USB), a Zigbee, a near field communication (NFC), a radio-frequency identification (RFID), a power line communication (PLC), or mobile cellular networks such as 3rd generation (3G), long term evolution (LTE), 4th generation (4G), and/or 5th generation (5G). The Bluetooth interface may support Bluetooth low energy (BLE).

In some example embodiments, the IoT device 1100 may include a communication interface 1020 for communicating with the outside. The communication interface 1020 may be, for example, a modem communication interface that is accessible to a wireless local area network such as an LAN, Bluetooth, Wi-Fi, and/or Zeebee, PLC, a mobile communication network, such as 3G, LTE, 4G, and/or 5G, etc., but example embodiments are not limited thereto.

The IoT device 1100 according to some example embodiments may be understood to include substantially the same configuration as the electronic device 100 illustrated in FIG. 1A.

The communication interface 1020 may include a transmitter and/or a receiver. Here, the communication interface 1020 illustrated in FIG. 11 may be understood to include the radar antenna 120 illustrated in FIG. 1A.

The IoT device 1100 may transmit and/or receive information from an access point or a gateway through the transmitter and/or the receiver. In some example embodiments, the IoT device 1100 may communicate with a user apparatus or any other IoT device to transmit and/or receive control information and/or data of the IoT device 1100.

The IoT device 1100 may include a processor 1010 that performs arithmetic operations. Here, the processor 1010 illustrated in FIG. 11 may be referenced as having substantially the same configuration as the processor 110 illustrated in FIG. 1A.

According to some example embodiments, the processor 1010 may obtain the Doppler velocity of the target object 10 identified within the threshold distance TR from the IoT device 1100 based on a signal received through the radar antenna 120. In some example embodiments, the processor 1010 may obtain the power of the tone signal based on the signals for identifying the target object 10.

Furthermore, the processor 1010 may obtain the power distribution PD of a tone signal according to the Doppler velocity.

Moreover, the processor 1010 may identify the type of motion performed by the target object 10 by calculating the correlation value CV1 or CV2 between the power distribution PD of the tone signal according to the Doppler velocity, and reference distributions RD1 and RD2 respectively corresponding to the different motions. Here, the different motions may be understood as operations having the same Doppler velocity and the same distance between the IoT device 1100 and the target object 10.

For example, the processor 1010 may distinguish between motions of the target object 10 performed in different directions with the same distance and the same Doppler velocity with respect to the IoT device 1100.

In this way, the IoT device 1100 according to some example embodiments of the present inventive concepts may increase the types of motions of the target object 10 identifiable through the radar antenna 120.

For internal power supply, the IoT device 1100 may further include an embedded battery (not shown) or a power supply unit (not shown) that is supplied with a power from the outside. In some example embodiments, the IoT device 1100 may include a display 1040 for displaying an internal state and/or data. A user may control the IoT device 1100 through a user interface (UI) of the display 1040 in the IoT device 1100. The IoT device 1100 may transmit an internal state and/or data to the outside through the transmitter and may receive a control instruction and/or data from the outside through the receiver.

A memory 1030 may store a control instruction code controlling the IoT device 1100, control data, and/or user data. The memory 1030 may include at least one of a volatile memory or a nonvolatile memory. The nonvolatile memory includes at least one of various memories such as a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (ReRAM), and a ferroelectric RAM (FRAM). The volatile memory may include at least one of various memories such as a static RAM (SRAM), a dynamic RAM (DRAM), and a synchronous DRAM (SDRAM).

Here, the memory 1030 illustrated in FIG. 11 may be referenced as having substantially the same configuration as the memory 130 illustrated in FIG. 1B. Accordingly, in some example embodiments, the memory 1030 may store a plurality of instructions ITs for controlling the IoT device 1100 via the processor 1010.

In some example embodiments, the IoT device 1100 may further include a storage device (not shown). The storage device may include at least one of nonvolatile media such as a solid state drive (SSD), an embedded multimedia card (eMMC), and universal flash storage (UFS). The storage device may store user information provided through an input/output unit (I/O) 1050 and pieces of sensing information collected through a sensor 1060.

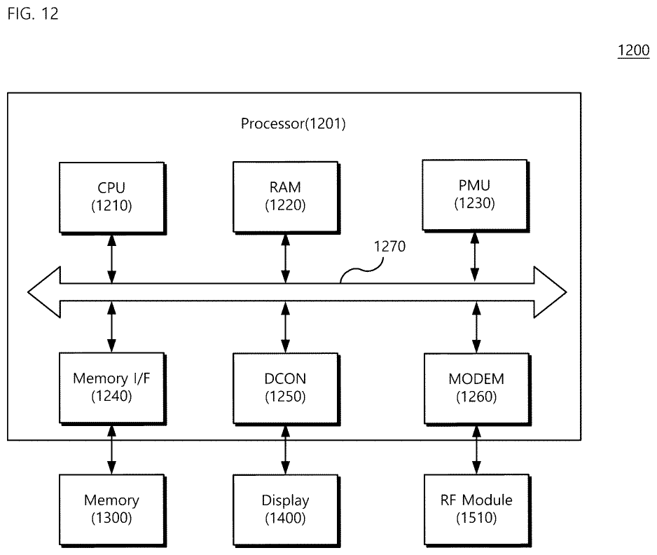

FIG. 12 is a block diagram showing a mobile terminal, to which an electronic device is applied, according to some example embodiments.

Referring to FIG. 12, the mobile terminal 1200 may include a processor 1201, a memory 1300, a display 1400, and a radio frequency (RF) module 1510. In some example embodiments, the mobile terminal 1200 may further include various components such as a lens and/or an audio module.

The processor 1201 may be implemented with a system on chip (SoC) and may include a central processing unit (CPU) 1210, a RAM 1220, a power management unit (PMU) 1230, a memory interface (I/F) 1240, a display controller (DCON) 1250, a MODEM 1260, and a bus 1270. In some example embodiments, the processor 1201 may further include various intellectual properties (IPs). The processor 1201 may be integrated with a function of a MODEM chip therein, which is referred to as a “ModAP”, but example embodiments are not limited thereto.

In some example embodiments, the processor 1201 illustrated in FIG. 12 may be referenced as having substantially the same configuration as the processor 110 illustrated in FIG. 1A.

The CPU 1210 may control overall operations of the processor 1201 and the mobile terminal 1200. The CPU 1210 may control an operation of each component of the processor 1201. In some example embodiments, the CPU 1210 may be implemented with a multi-core. The multi-core may be one computing component having two or more independent cores.

The RAM 1220 may temporarily store programs, data, and/or instructions. For example, the programs and/or data stored in the memory 1300 may be temporarily stored in the RAM 1220 under control of the CPU 1210 or depending on a booting code. The RAM 1220 may be implemented with a DRAM or an SRAM.

The PMU 1230 may manage power of each component of the processor 1201. The PMU 1230 may also determine an operating situation of each component of the processor 1201 and may control an operation thereof. For example, the PMU 1230 may determine an operational state of each component of the processor 1201 and may control the operations of each component of the processor 1201.

The memory interface 1240 may control overall operations of the memory 1300 and may control data exchange of the memory 1300 with each component of the processor 1201. Depending on a request of the CPU 1210, the memory interface 1240 may write data in the memory 1300 and/or may read data from the memory 1300. The memory 1300 illustrated in FIG. 12 may be referenced as having substantially the same configuration as the memory 130 illustrated in FIG. 1B.

The display controller 1250 may provide the display 1400 with image data to be displayed on the display 1400. The display 1400 may be implemented with a flat panel display, such as a liquid crystal display (LCD) and/or an organic light emitting diode (OLED) display, and/or a flexible display.

For wireless communication, the MODEM 1260 may modulate data to be transmitted so as to be appropriate for a wireless environment and may recover received data. The MODEM 1260 may perform digital communication with the RF module 1510.

According to some example embodiments, the RF module 1510 may be electrically connected to the radar antenna 120 illustrated in FIG. 1A.

In some example embodiments, the RF module 1510 may convert a high-frequency signal received through the radar antenna 120 into a low-frequency signal and may transmit the converted low-frequency signal to the MODEM 1260. In some example embodiments, the RF module 1510 may convert a low-frequency signal received from the MODEM 1260 into a high-frequency signal and may transmit the converted high-frequency signal to the outside of the mobile terminal 1200 through the radar antenna 120. The RF module 1510 may amplify and/or filter a signal.

According to some example embodiments, the processor 1201 may obtain the Doppler velocity of the target object 10 identified within the threshold distance TR from the mobile terminal 1200 based on a signal received through the radar antenna 120. In some example embodiments, the processor 1201 may obtain the power of the tone signal based on the signals for identifying the target object 10.

Furthermore, the processor 1201 may obtain the power distribution PD of a tone signal according to the Doppler velocity.

Moreover, the processor 1201 may identify the type of motion performed by the target object 10 by calculating the correlation value CV1 or CV2 between the power distribution PD of the tone signal according to the Doppler velocity, and reference distributions RD1 and RD2 respectively corresponding to the different motions. Here, the different motions may be understood as operations having the same Doppler velocity and the same distance between the mobile terminal 1200 and the target object 10.

For example, the processor 1201 may distinguish between motions of the target object 10 performed in different directions with the same distance and the same Doppler velocity with respect to the mobile terminal 1200.

In this way, the mobile terminal 1200 according to some example embodiments of the present inventive concepts may increase the types of motions of the target object 10 identifiable through the radar antenna 120.

As described above, the processor 110 according to some example embodiments of the present inventive concepts may obtain the Doppler velocity of the target object 10, and the power of the tone signal obtained in a process of detecting the target object 10 based on the signal received through the radar antenna 120.

Furthermore, the processor 110 may obtain the power distribution of a tone signal according to the Doppler velocity.

Here, the processor 110 may normalize the Doppler velocity and/or the power of the tone signal. For example, the processor 110 may normalize the Doppler velocity and/or the power of a tone signal to have values within a specified range.

In this way, the processor 110 according to some example embodiments of the present inventive concepts may reduce the impact of an operation of identifying the motion of each target object by using a difference in characteristics (e.g., a size, humidity, a distance, and an operating speed) between different target objects.

In some example embodiments, the processor 110 may identify the type of motion performed by the target object 10 by calculating a correlation value (or similarity) between the power distribution of the tone signal according to the Doppler velocity, and each of reference distributions respectively corresponding to the different motions. Here, the different motions may be understood as operations having the same Doppler velocity and the same distance between the electronic device 100 and the target object 10.

For example, the processor 110 may distinguish between motions of the target object 10 performed in different directions with the same distance and the same Doppler velocity with respect to the electronic device 100.

In this way, the electronic device 100 according to some example embodiments of the present inventive concepts may increase the types of motions of the target object 10 identifiable through the radar antenna 120.

Example embodiments in which a design is changed simply, or which are easily changed may be included in the present inventive concepts as well as the example embodiments described above. In addition, technologies that are easily changed and implemented by using the above described example embodiments may be included in the present inventive concepts. Accordingly, it will be apparent to those of ordinary skill in the art that various changes and modifications may be made to the above example embodiments without departing from the spirit and scope of the present inventive concepts as set forth in the following claims.

An electronic device, according to some example embodiments of the present inventive concepts may increase the types of motions identifiable through a radar antenna.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operation tolerance (e.g., +10%) around the stated elements and/or properties thereof.

Further, any or all of the elements described with reference to the figures may communicate with any or all other elements described with reference to the figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be encoded in various formats, such as in an analog format and/or in a digital format.

According to some example embodiments, as described herein, there is provided an Internet of Things (IoT) device including an electronic device. The electronic device including a radar antenna configured to transmit and receive a radio frequency signal, and a processor configured to identify a motion of a target object based on a signal received through the radar antenna, the processor further configured to obtain a Doppler velocity of the target object and power of a tone signal obtained in an operation of detecting the target object during a measurement time; obtain a power distribution of the tone signal according to the Doppler velocity; calculate a first correlation value between the power distribution and a first reference distribution corresponding to a first motion of the target object, and a second correlation value between the power distribution and a second reference distribution corresponding to a second motion of the target object; and determine the motion of the target object as the first motion in response to the first correlation value being greater than the second correlation value.

In some example embodiments, the processor is configured to determine a distance between the IoT device and the target object based on the signal received through the radar antenna and measure the Doppler velocity and the power of the tone signal in response to the distance being less than or equal to a threshold distance.

In some example embodiments, the processor is configured to normalize the Doppler velocity measured during the measurement time by dividing each of a plurality of values of the Doppler velocity measured during the measurement time by a maximum value among the plurality of values of the Doppler velocity measured during the measurement time; add power values of the tone signal corresponding to each of the normalized plurality of values of the Doppler velocity and obtain a power sum distribution according to the normalized Doppler velocity; and obtain the power distribution by normalizing the power sum distribution such that a sum of the power values has a specified value.

While the present inventive concepts have been described with reference to some example embodiments thereof, it will be apparent to those of ordinary skill in the art that various changes and modifications may be made thereto without departing from the spirit and scope of the present inventive concepts as set forth in the following claims.

What is claimed is:

1. An electronic device, comprising:
a radar antenna configured to send and receive a radio frequency (RF) signal; and
a processor configured to identify a motion of a target object based on a signal received through the radar antenna, the processor further configured to,
obtain a Doppler velocity of the target object and power of a tone signal obtained in an operation of detecting the target object during a measurement time;
obtain a power distribution of the tone signal according to the Doppler velocity;
calculate a first correlation value between the power distribution and a first reference distribution corresponding to a first motion of the target object, and a second correlation value between the power distribution and a second reference distribution corresponding to a second motion of the target object; and
determine the motion of the target object as the first motion in response to the first correlation value being greater than the second correlation value.

2. The electronic device of claim 1, wherein the processor is configured to:
determine a distance between the electronic device and the target object based on the signal received through the radar antenna; and
measure the Doppler velocity and the power of the tone signal in response to the distance being less than or equal to a threshold distance.

3. The electronic device of claim 1, wherein the processor is configured to:
normalize the Doppler velocity measured during the measurement time by dividing each of a plurality of values of the Doppler velocity measured during the measurement time by a maximum value among the plurality of values of the Doppler velocity measured during the measurement time;
add power values of the tone signal corresponding to each of the normalized plurality of values of the Doppler velocity and obtain a power sum distribution according to the normalized Doppler velocity; and
obtain the power distribution by normalizing the power sum distribution such that a sum of the power values has a specified value.

4. The electronic device of claim 1, wherein the processor is configured to:
obtain the first correlation value through a correlation operation between a measurement vector extracted from the power distribution and a first reference vector extracted from the first reference distribution; and
obtain the second correlation value through a correlation operation between the measurement vector and a second reference vector extracted from the second reference distribution.

5. The electronic device of claim 4, the processor is configured to:
obtain the first correlation value by dividing an inner product between the measurement vector and the first reference vector by an absolute value of the first reference vector.

6. The electronic device of claim 2, wherein
the first motion is a motion that the target object moves in a first direction at the distance from the electronic device, and
the second motion is a motion that the target object moves in a second direction different than the first direction at the distance from the electronic device.

7. The electronic device of claim 1, wherein the radar antenna includes a first antenna configured to transmit a transmission signal of a frequency band, and a second antenna configured to receive a reception signal reflected from the target object.

8. The electronic device of claim 7, wherein the tone signal corresponds to a difference in frequency between the transmission signal and the reception signal.

9. The electronic device of claim 2, the processor is configured to:
identify the target object within the threshold distance through a constant false alarm rate (CFAR) for at least part of the Doppler velocity and the distance between the electronic device and the target object.

10. A method of operating an electronic device for identifying a motion of a target object, the method comprising:
obtaining a Doppler velocity of the target object, and power of a tone signal obtained in an operation of detecting the target object during a measurement time;
obtaining a power distribution of the tone signal according to the Doppler velocity;
calculating a first correlation value between the power distribution and a first reference distribution corresponding to a first motion of the target object, and a second correlation value between the power distribution and a second reference distribution corresponding to a second motion of the target object; and
determining the motion of the target object as the first motion in response to the first correlation value being greater than the second correlation value.

11. The method of claim 10, wherein the obtaining of the Doppler velocity and the power of the tone signal further includes:
determining a distance between the electronic device and the target object based on a signal received through a radar antenna; and
measuring the Doppler velocity and the power of the tone signal based on the signal received through the radar antenna in response to the distance being less than or equal to a threshold distance.

12. The method of claim 11, wherein the obtaining of the power distribution further includes:
normalizing the Doppler velocity by dividing each of a plurality of values of the Doppler velocity measured during the measurement time by a maximum value among the plurality of values of the Doppler velocity measured during the measurement time;
adding power values of the tone signal corresponding to each of the normalized plurality of values of the Doppler velocity;
obtaining a power sum distribution according to the normalized Doppler velocity; and
obtaining the power distribution by normalizing the power sum distribution such that a sum of the power values has a specified value.

13. The method of claim 11, wherein the calculating of the first correlation value further includes calculating the first correlation value by dividing an inner product between a measurement vector extracted from the power distribution and a first reference vector extracted from the first reference distribution by an absolute value of the first reference vector.

14. The method of claim 11, wherein
the first motion is a motion that the target object moves in a first direction at the distance from the electronic device, and
the second motion is a motion that the target object moves in a second direction different than the first direction at the distance from the electronic device.

15. The method of claim 11, further comprising:
identifying the target object within the threshold distance through a constant false alarm rate (CFAR) for at least part of the Doppler velocity and the distance between the electronic device and the target object.

16. An electronic device, comprising:
a radar antenna configured to transmit a transmission signal and receive a reception signal reflected from a target object;
a processor configured to identify a motion of the target object based on the reception signal; and
a memory configured to store instructions and operatively connected to the processor, the processor configured to,
obtain a Doppler velocity of the target object, and power of a tone signal obtained in an operation of detecting the target object during a measurement time;
obtain a power distribution of the tone signal according to the Doppler velocity from power values of the tone signal corresponding to each of a plurality of values of the Doppler velocity measured during the measurement time;
calculate a first correlation value between the power distribution and a first reference distribution corresponding to a first motion, and a second correlation value between the power distribution and a second reference distribution corresponding to a second motion; and
determine the motion of the target object as the first motion in response to the first correlation value being greater than the second correlation value.

17. The electronic device of claim 16, wherein the processor is configured to:
determine a distance between the electronic device and the target object based on the reception signal; and
measure the Doppler velocity and the power of the tone signal in response to the distance being less than or equal to a threshold distance.

18. The electronic device of claim 16, wherein the processor is configured to:
normalize the Doppler velocity by dividing each of the plurality of values of the Doppler velocity measured during the measurement time by a maximum value among the plurality of values of the Doppler velocity measured during the measurement time;
add power values of the tone signal corresponding to each of the normalized plurality of values of the Doppler velocity;
obtain a power sum distribution according to the normalized Doppler velocity; and
obtain the power distribution by normalizing the power sum distribution such that a sum of the power values has a specified value.

19. The electronic device of claim 16, wherein the processor is configured to calculate the first correlation value by dividing an inner product between a measurement vector extracted from the power distribution and a first reference vector extracted from the first reference distribution by an absolute value of the first reference vector.

20. The electronic device of claim 17, wherein
the first motion is a motion that the target object moves in a first direction at the distance from the electronic device, and
the second motion is a motion that the target object moves in a second direction distinct from the first direction at the distance from the electronic device.
